(19) United States
(12) Patent Application Publication
(10) Pub. No.: US 2010/0118660 A1
(43) Pub. Date: May 13, 2010

(54) TIME/DATE INFORMATION PROVIDING SYSTEM AND TIME/DATE INFORMATION PROVIDING METHOD

(75) Inventors: Naoki FUJISAWA, Tokyo (JP); Daisuke Yano, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/603,041

(22) Filed: Oct. 21, 2009

(30) Foreign Application Priority Data
Nov. 10, 2008 (JP) 2008-287515

(51) Int. Cl. G04B 19/24

(52) U.S. Cl. 368/28; 368/10

(57) ABSTRACT

A time/date information providing system is provided which includes a time/date information providing server for managing time/date information which is registered by information providers for providing various items of information associated with time and date as the time/date information, a calendar service providing server for providing a calendar service of performing schedule management on a user's schedule in association with time and date, acquiring the time/date information registered in the time/date information providing server, and providing the time/date information to the user in the calendar service, and at least one or more information processing terminals for accessing the calendar service providing server or the time/date information providing server via a communication network to acquire the time/date information from the calendar service providing server or the time/date information providing server.

### BACKGROUND OF THE INVENTION

1. Field of the Invention

The present invention relates to a time/date information providing system and a time/date information providing method.

2. Description of the Related Art

A user utilizes schedule management software installed in a personal computer or the like to manage various items of information on a release date of new product or a time/date or period of cinema, concert or sports game in association with a calendar.

### SUMMARY OF THE INVENTION

However, such various items of information on a release date or event information are provided as a single item of information from information providers, sponsors and the like, respectively, in many case. Thus, consumers need to use some means such as newspaper, magazine, television, radio and Internet to acquire the information and to register the same as schedule information.

Therefore, there was an issue that the user may not acquire the information to reflect the same on the schedule management depending on the presence of an access means for accessing various items of information on a release date or event information, or an access timing. Further, there was an issue that the information providers may not accurately provide provision-intended information to the users who may desire the information.

The present invention has been therefore made in views of the above issues, and it is desirable for the present invention to provide a novel and improved time/date information providing system and time/date information providing method capable of efficiently providing various items of time/date information on release dates or event information via a communication network.

According to an embodiment of the present invention, there is provided a time/date information providing system including a time/date information providing server for managing time/date information which is registered by information providers for providing various items of information associated with time and date as the time/date information, a calendar service providing server for providing a calendar service of performing schedule management on a user's schedule in association with time and date, acquiring the time/date information registered in the time/date information providing server, and providing the time/date information to the user in the calendar service, and at least one or more information processing terminals for accessing the calendar service providing server or the time/date information providing server via a communication network to acquire the time/date information from the calendar service providing server or the time/date information providing server.

In the configuration of the time/date information providing system according to the embodiment of the invention, the time/date information providing server can manage time/date information which is registered by information providers for providing various items of information associated with time and date as the time/date information. The calendar service providing server can provide a calendar service of performing schedule management on a user's schedule in association with time and date, acquiring the time/date information registered in the time/date information providing server, and providing the time/date information to the user in the calendar service. At least one or more information processing terminals can access the calendar service providing server or the time/date information providing server via a communication network to acquire the time/date information from the calendar service providing server or the time/date information providing server.

When the user selects predetermined time/date information via the information processing terminal, the calendar service providing server may manage the time/date information in association with information on the user's schedule to provide the calendar service.

The time/date information providing system may further include a meta information providing server for managing meta information which is registered by meta information providers for providing the meta information associated with the time/date information. The information processing terminal may access the meta information providing server via the communication network to acquire the meta information.

The time/date information providing server may acquire the meta information registered in the meta information providing server, and may add the meta information to time/date information registered by the information providers for management.

The calendar service providing server may acquire the time/date information registered in the time/date information providing server every preset constant period.

The calendar service providing server may manage information on preference of the user as preference information, and may provide only time/date information suitable for the preference information among the time/date information to the user in the calendar service.

The time/date information may be managed in the time/date information providing server and the calendar service providing server while being stylized in a preset format.

According to another embodiment of the present invention, there is provided a time/date information providing method, including the steps of registering time/date information in a time/date information providing server by information providers for providing various items of information associated with time and date as the time/date information, acquiring the time/date information registered in the time/date information providing server by a calendar service providing server for providing a calendar service of managing a user's schedule in association with time and date to the user, and providing the time/date information to the information processing terminal by the time/date information providing server when an access is made to the time/date information providing server via a communication network from at least one or more information processing terminals, and providing the time/date information to the information processing terminals in the calendar service by the calendar service providing server when an access is made to the calendar service providing server.

As described above, according to the present invention, it is possible to efficiently provide various items of time/date information on release dates or event information via a communication network.

### BRIEF DESCRIPTION OF THE DRAWINGS

FIG. 1 is a block diagram showing the entire structure of a time/date information providing system 100 according to one embodiment;

FIG. 2 is an explanatory diagram showing a concept in which meta information is added to time/date data recording therein time/date information according to the embodiment;

FIG. 3 is an explanatory diagram showing a concept in which an information processing terminal 102 receives only information suitable for user's preference information from each providing server based on registered preference information according to a variant of the embodiment;

FIG. 4 is an explanatory diagram showing a concept in which each providing server transmits predetermined information to only specific information processing terminals 102 based on the registered preference information according to the variant of the embodiment;

FIG. 5 is an explanatory diagram showing a concept in which each providing server receives a request signal of requesting to transmit various items of information from only specific information processing terminals 102 according to the variant of the embodiment;

FIG. 6 is an explanatory diagram showing a concept in which each providing server filters only predetermined information together among a plurality of items of information to be managed and transmits the same to the information processing terminals 102 or other providing servers according to the variant of the embodiment; and

FIG. 7 is an explanatory diagram showing a concept in which only specific information is extracted by each providing server among a plurality of categories of information provided by a certain information provider and is transmitted to the information processing terminals 102 according to the variant of the embodiment.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted. The explanation will be made in the following order.

1. Outline of embodiment of the present invention

2. Structure of time/date information providing system 100 according to one embodiment

3: Variant (Filtering restriction of transmission and/or reception of time/date information)

4: Conclusion

(1. Outline of Embodiment of the Present Invention)

The outline of one embodiment will be described prior to explaining the time/date information providing system 100 according to one embodiment of the present invention in detail.

As previously described, a user utilizes schedule management software installed in a personal computer or the like to manage his/her schedule. For example, information on release dates of new products, dates or periods of events such as cinemas, concerts and sports games is registered so that the user can manage the items of information in association with a calendar. However, typically various items of information on release dates of products, dates or periods of various events (referred to as “time/date information” below) are irregularly provided to unspecified users by providers or sponsors via various methods or information mediums.

Thus, the user needs to utilize, for example, newspapers, magazines, television, radio, Internet WEB (World Wide Web) sites for individually acquiring various items of time/date information. For example, the user needs to acquire time/date information on sports game on a WEB site, to acquire information on a release date of new CD from a music magazine, or to acquire information on a broadcast time/date of TV program from a TV program guide. Further, in order to register various items of time/date information in a calendar service for schedule management, the user needed a complicated work of acquiring and registering the time/date information via various information mediums. Thus, there was an issue that when the user does not have any information medium or when the user is too late to acquire, the user may not acquire the time/date information and perform appropriate schedule management. Further, there was an issue that the time/date information providers such as information providers or sponsors may not accurately provide the provision-intended time/date information to the users who may desire the time/date information, thereby losing a business chance.

The time/date information providing system 100 according to the embodiment of the present invention can solve the issues and can efficiently provide various items of time/date information on release dates or event information via a communication network.

Specifically, the time/date information providing system 100 includes a calendar service providing server and a time/date information distribution service providing server on a network such as Internet for providing time/date information to multiple users' information processing terminals connectable to the network. The calendar service providing server provides a calendar service, that is, a service for user's schedule management to each user. Thus, the user utilizes an information processing terminal connectable to the network, such as personal computer or cell phone, to access the calendar service providing server, thereby managing his/her schedule.

The time/date information distribution service providing server can manage various items of time/date information registered by sponsors and the like and appropriately provide the time/date information to the calendar service providing server. Thus, the user can view various items of time/date information when accessing the calendar service providing server from the information processing terminal to view his/her calendar information. Therefore, the user registers time/date information suitable for his/her preference in association with the calendar, thereby performing the schedule management on the time/date information of his/her interested products or events. Consequently, the user does not need a complicated work of utilizing different information mediums such as WEB sites, television, newspapers and magazines for retrieving desired time/date information, or saving and managing the time/date information in his/her information processing terminal. Furthermore, the information providers such as sponsors register the provision-intended time/date information in the time/date information distribution service providing server, thereby accurately providing the time/date information to the users who have accessed the calendar service providing server.

In this manner, the time/date information providing system 100 according to the embodiment of the present invention can efficiently provide various items of time/date information on release dates or event information via a communication network. In the following, the time/date information providing system 100 according to the embodiment of the present invention having the above characteristics will be described in detail.

(1. Structure of Time/Date Information Providing System 100 According to One Embodiment)

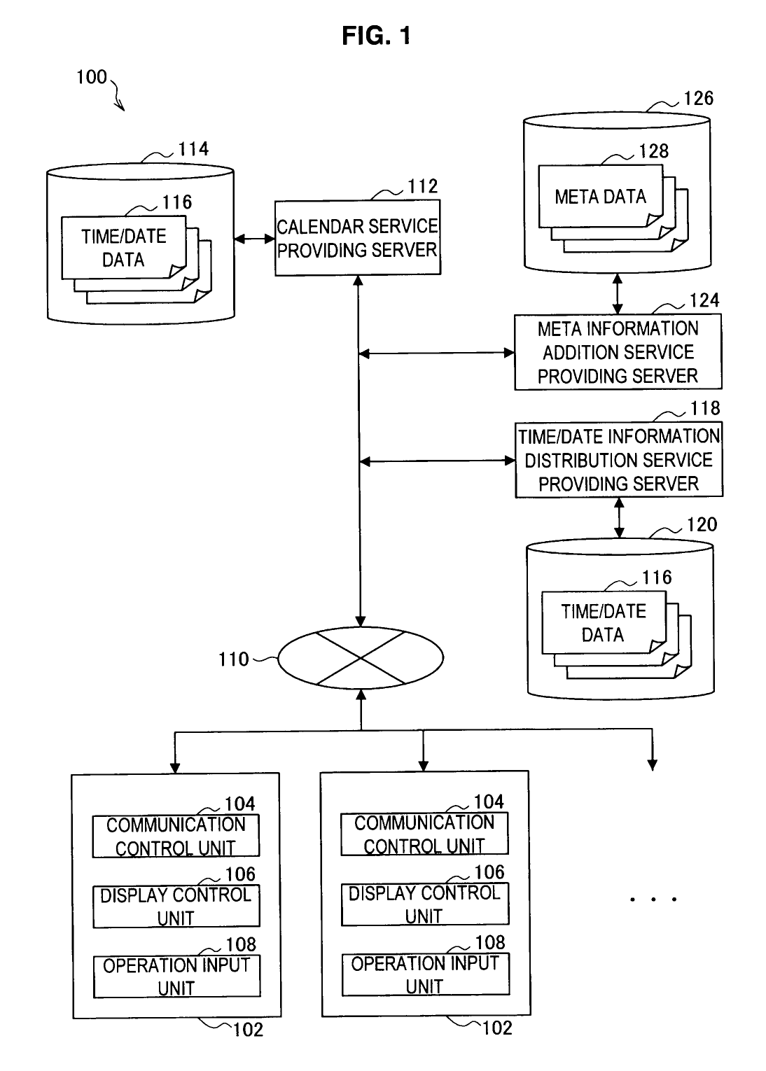

At first, the entire structure of the time/date information providing system 100 according to one embodiment of the present invention will be described. FIG. 1 is a block diagram showing the entire structure of the time/date information providing system 100 according to the present embodiment.

As shown in FIG. 1, the time/date information providing system 100 according to the present embodiment mainly includes a plurality of information processing terminals 102, a calendar service providing server 112, a time/date information distribution service providing server 118 and a meta information addition service providing server 124. The calendar service providing server 112, the time/date information distribution service providing server 118 and the meta information addition service providing server 124 are directed for providing various services on a network such as Internet. The user can access various servers from each information processing terminal 102 via a communication network 110 such as Internet to transmit and/or receive various items of information. Further, the servers can transmit and/or receive various items of information via the communication network 110. In the following, each constituent in the time/date information providing system 100 according to the present embodiment will be described in detail.

(Information Processing Terminal 102)

As shown in FIG. 1, the information processing terminal 102 mainly includes a communication control unit 104, a display control unit 106 and an operation input unit 108.

The communication control unit 104 performs communication control of various items of data transmitted and/or received between the calendar service providing server 112, the time/date information distribution service providing server 118 and the meta information addition service providing server 124 via the communication network 110. Specifically, the communication control unit 104 transmits a signal of requesting various items of data to various providing servers via the communication network 110 in response to a user's instruction via the operation input unit 108 described later, thereby receiving desired data from various providing servers.

The communication control unit 104 can use a communication interface configured with a communication device or the like provided in the information processing terminal 102 for connecting to the communication network 110 to transmit and/or receive various items of information. The communication device may include, for example, a communication card for wired or wireless LAN, Bluetooth (trademark) or WUSB, a router for optical communication or ADSL, or a modem for various communications, but is not limited to specific communication devices.

The display control unit 106 performs display control when each processing unit provided in the information processing terminal 102 according to the present embodiment displays various items of data or information on a display unit (not shown). The display control unit 106 can display calendar information acquired from the calendar service providing server 112, time/date information acquired from the time/date information distribution service providing server 118 or the like, for example, on the display unit.

The display unit displaying thereon various items of information by the display control unit 106 may include a CRT display device, a liquid crystal display device, a plasma display device, an organic EL display device and the like, for example, but is not limited to specific display devices.

When the user operates an operation unit (not shown) to instruct the information processing terminal 102 about various processings, the operation input unit 108 transmits instruction information corresponding to the instruction to each function unit of the information processing terminal 102. For example, the communication control unit 104 and the display control unit 106 described above can transmit and/or receive various items of data based on the user's instruction information transmitted from the operation input unit 108, or display various items of information.

The user-operable operation unit may include mouse, keyboard, touch panel, button, switch, lever and the like, for example, but is not limited to specific operation units as long as it is user-operable.

There has been described above the functional structure of the information processing terminal 102 configuring the time/date information providing system 100 according to the present embodiment, but the functional structure shown in FIG. 1 is one example for explaining the present embodiment and is not limited thereto. Further, the information processing terminal 102 may include personal computer, television receiver, cell phone, PDA, portable music player and the like, for example, but is not limited to specific devices as long as it has each function described above. Furthermore, the time/date information providing system 100 according to the present embodiment may include a plurality of information processing terminals 102, and the information processing terminals 102 may be different as long as they include each function described above. Therefore, the user utilizes a personal computer installed at his/her home to access various providing servers or utilizes a cell phone outside his/her home to access various providing servers, thereby utilizing the time/date information providing system 100.

(Calendar Service Providing Server 112)

Next, the calendar service providing server 112 is directed for providing a calendar service to the users on a network. The calendar service is a service of providing information on year, month and date and user's schedule information to be associated for schedule management to each user. The user can access the calendar service providing server 112 from the information processing terminal 102 to view his/her schedule information associated with the information on year, month and date. Thus, the calendar service providing server 112 includes a storage area such as a calendar information storage unit 114 for storing therein a database of the schedule information managed for each user.

Further, the calendar service providing server 112 can receive time/date data 116 recording therein various items of time/date information from the time/date information distribution service providing server 118 described later to store the same in the calendar information storage unit 114. Thus, the user can view various items of time/date information provided by various sponsors when accessing the calendar service providing server 112 from the information processing terminal 102 to view his/her schedule information. At this time, when finding time/date information on preferred events or products, the user can register the time/date information in association with his/her schedule information. In response thereto, the calendar service providing server 112 can record the user-registered time/date information in the database in association with the user's schedule information. Therefore, each time the user accesses the calendar service providing server 112, the user can confirm the registered time/date information, that is, a release date of preferred product or a date of event as his/her schedule information.

The calendar service providing server 112 can automatically acquire the time/date data 116 from the time/date information distribution service providing server 118 or acquire predetermined time/date data in response to a user's instruction every constant period. The method or period for acquiring the time/date data 116 by the calendar service providing server 112 may be arbitrarily set and changed by a system manager or user, and is not limited to specific acquiring methods or acquiring periods.

(Time/Date Information Distribution Service Providing Server 118)

Next, the time/date information distribution service providing server 118 is directed for providing time/date information to the users on a network and functions as the time/date information providing server according to the present invention. As described above, the time/date information is provided by the information providers such as sponsors, like release dates of products and dates or periods of events, for example. The time/date information may include release dates of CDs or books, broadcast time/date of television programs, release dates of new products, playdays of cinema or concerts, dates of sports games such as baseball or soccer, event schedule of the Olympic games, and the like. Further, the time/date information may be information associated with time and date such as birthdays of famous persons, bargain days of supermarkets, “what day it is today”, and weather forecast associated with time and date, and is not limited to the specific information.

Previously, the time/date information was individually provided to unspecified users via unspecified information mediums by the information providers such as sponsors having the items of time/date information. On the contrary, when the time/date information providing system 100 according to the present embodiment is utilized, if having provision-intended time/date information, the information provider registers the time/date information in the time/date information distribution service providing server 118. In response thereto, the time/date information distribution service providing server 118 saves the time/date data 116 recording therein the time/date information registered by the information providers in the storage area such as time/date data storage unit 120.

The user can access the time/date information distribution service providing server 118 via the communication network 110 from the information processing terminal 102 to view and acquire his/her desired time/date information. Further, the user can register the thus acquired time/date information in the schedule information provided by the calendar service providing server 112 via the communication network 110. In response thereto, the calendar service providing server 112 can record the user-registered time/date information in the database in association with the user's schedule information. As a result, the user can view the time/date information on registered products or events when viewing his/her schedule through the calendar service.

Furthermore, the calendar service providing server 112 can acquire the time/date data from the time/date information distribution service providing server 118 every constant period and save the same in the calendar information storage unit 114 or the like, for example. Thus, the user can view various items of time/date information provided by various sponsors when accessing the calendar service providing server 112 via the communication network 110 from the information processing terminal 102 to view his/her schedule information. At this time, if finding preferred events or products, the user can register the time/date information on the events or products in association with his/her schedule information. In response thereto, the calendar service providing server 112 can record the user-registered time/date information in the database in association with the user's schedule information. Consequently, the user can view the time/date information on registered products or events when viewing his/her schedule through the calendar service.

In this manner, the information providers such as sponsors can provide the time/date information to all the users utilizing the calendar service provided by the calendar service providing server 112 only by registering the provision-intended time/date information in the time/date information distribution service providing server 118. As a result, when utilizing the calendar service to view user's own schedule, the user can view and manage the time/date information together.

In the present embodiment, the time/date data 116 recording the time/date information therein is stylized in a predefined format and is transmitted and/or received on the time/date information providing system 100 in a unified manner, for example. The format information recoded in the time/date data 116 includes time/date (period), subject, location and the like, for example, but is not limited thereto. In other words, the recording format of the time/date data 116 is set and changed by a system manager or the like, and is not limited to specific information. Further, the format information recorded in the time/date data 116 may include meta information provided by the meta information addition service providing server 124 described later. The meta information may include explanation, associated HP's URL, icon's URL, image's URL, retrieval tag, transmitter information, processor information, extension information and the like, for example, but is not limited thereto.

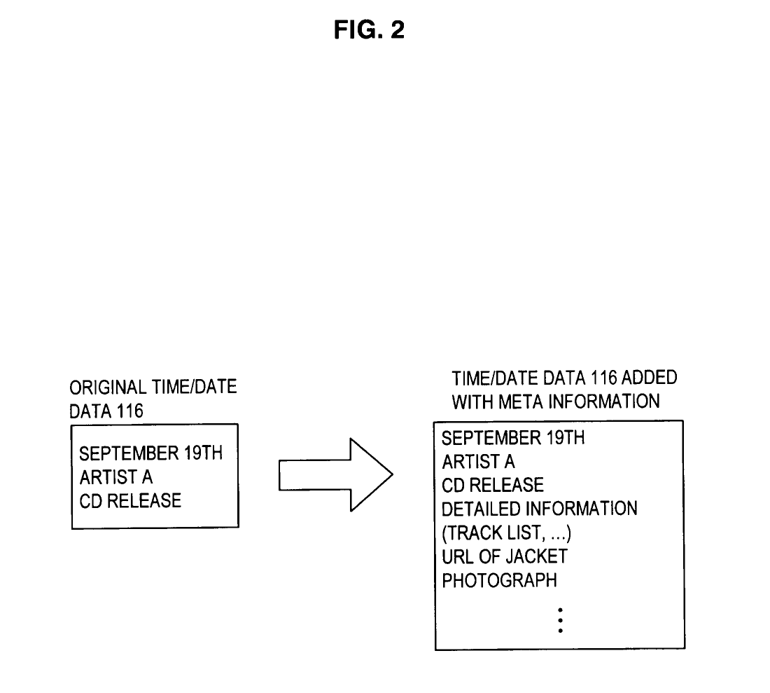

FIG. 2 is an explanatory diagram showing a concept in which meta information is added to the time/date data 116. With reference to FIG. 2, it can be seen that the original time/date data 116 records therein time/date information on a CD release date of “Artist A”. On the contrary, it can be seen that the time/date data added with the meta information is added with various items of information such as track list of the CD or URL of its jacket photograph.

As described above, the recording format of the time/date data 116 utilized on the time/date information providing system 100 is unified so that the time/date information can be more efficiently provided to the user. For example, the calendar service providing server 112 can manage the time/date data 116 acquired from the time/date information distribution service providing server 118 without performing any processing such as format conversion. Furthermore, various items of time/date information recorded in the time/date data 116 can be previously notified to the users' information processing terminals 102 prior to the first date of event indicated by the time/date information. Further, also when directly acquiring the time/date data 116 from the time/date information distribution service providing server 118, the user can edit and add the information in conformity to the recording format and register the same in the calendar service providing server 112.

(Meta Information Addition Service Providing Server 124)

Then, the meta information addition service providing server 124 is directed for providing meta information associated with time/date information to the users over a network, and functions as the meta information providing server in the present invention. As stated above, the time/date data 116 records therein time/date information on products or events such as time/date (period), subject and location. The meta information addition service providing server 124 manages detailed information on the products or events, for example, the information on explanation, associated HP's URL, icon's URL, image's URL and the like as the meta information.

Previously, the meta information was individually provided to unspecified users via unspecified information mediums by the meta information providers such as sponsors having the meta information. On the contrary, when utilizing the time/date information providing system 100 according to the present embodiment, if having the provision-intended meta information in addition to the time/date information on products or events, the meta information provider registers the meta information in the meta information addition service providing server 124. In response thereto, the meta information addition service providing server 124 saves meta data 128 recording therein the meta information registered by the meta information providers in the storage area such as a meta data storage unit 126.

The user can access the meta information addition service providing server 124 via the communication network 110 from the information processing terminal 102 to view and acquire the meta information associated with his/her desired time/date information. Further, the user can register the thus acquired meta information in the schedule information provided by the calendar service providing server 112 via the communication network 110. In response thereto, the calendar service providing server 112 can record the user-registered meta information in the database in association with the user's schedule information. Consequently, the user can view the meta information associated with the registered products or events when viewing his/her schedule through the calendar service.

Further, the time/date information distribution service providing server 118 can, for example, acquire the meta data 128 from the meta information addition service providing server 124 every constant period and add the meta information to the time/date information recorded in the time/date data 116 for saving. Thus, the user accesses the time/date information distribution service providing server 118 via the communication network 110 from the information processing terminal 102 to acquire the time/date data 116, thereby acquiring and viewing the meta information not only the time/date information on predetermined products or events. Therefore, if finding preferred events or products, the user can register the time/date information and the meta information on the events or products in association with his/her schedule information. In response thereto, the calendar service providing server 112 can record the time/date information and the meta information registered by the user in the database in association with the user's schedule information. Consequently, the user can view the time/date information and the meta information on the registered products or events when viewing his/her schedule through the calendar service.

As described above, the calendar service providing server 112 can acquire the time/date data 116 from the time/date information distribution service providing server 118 every constant period and save the same in the calendar information storage unit 114 or the like. The thus acquired time/date data 116 may be added with the meta information by the time/date information distribution service providing server 118 as described above. In such a case, the user can view various items of time/date information or meta information provided by various sponsors when accessing the calendar service providing server 112 via the communication network 110 from the information processing terminal 102 to view his/her schedule information. At this time, if finding preferred events or products, the user can register the time/date information or the meta information thereof in association with his/her schedule information. In response thereto, the calendar service providing server 112 can record the time/date information or the meta information registered by the user in the database in association with the user's schedule information. As a result, the user can view the time/date information and the meta information on the registered products or events when viewing his/her schedule through the calendar service.

In this manner, the meta information providers such as sponsors can provide the meta information to all the users utilizing the calendar service provided by the calendar service providing server 112 only by registering the provision-intended meta information in the meta information addition service providing server 124. As a result, the user can view and manage the meta information in addition to the time/date information when utilizing the calendar serve to view his/her own schedule or the like.

There has been described above the entire structure of the time/date information providing system 100 according to the present embodiment with reference to FIG. 1. The entire structure shown in FIG. 1 is merely one example for explaining how to provide the time/date information as a characteristic of the present embodiment, and the present invention is not limited to the structure shown in FIG. 1. For example, of course, the information processing terminal 102 can additionally include various functions such as broadcast receiving function, speech inputting/outputting function and photographing function depending on an apparatus to be utilized. Each providing server has been indicated as an independent providing server in FIG. 1 for convenient explanation, but one or two providing servers may include the functions provided by the providing servers, of course.

(3. Variant)

In the time/date information providing system 100 configured in the above manner, the filtering processing based on user's preference information enables arbitrary time/date data 116 or meta data 128 to be transmitted and/or received. In the following, a variant of the time/date information providing system 100 will be described.

The user can register his/her preference information and the like in the information processing terminal 102, for example. Thus, the information processing terminal 102 can receive only the information suitable for user's preference information from each providing server. The user-registered preference information may include categories of sports or music, hours of TV programs, entertainers, regions and the like, but is not limited thereto.

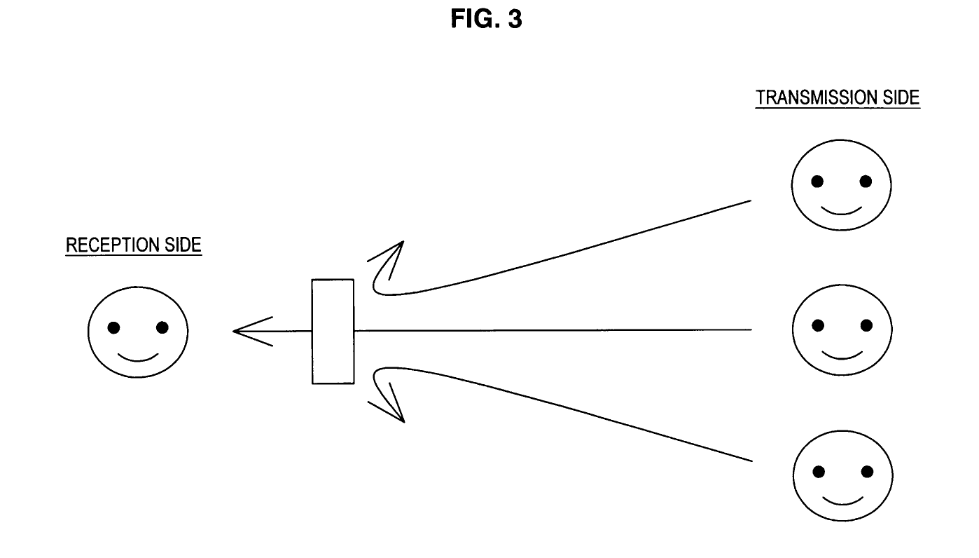

FIG. 3 is an explanatory diagram showing a concept in which the information processing terminal 102 receives only the information suitable for user's preference information from each providing server based on the registered preference information. As shown in FIG. 3, the information processing terminal 102 can filter and receive only the information suitable for the registered preference information among various items of information transmitted from each providing server and block other items of information. As a result, the user does not need to receive unnecessary information unsuitable for his/her preference.

The reception of various items of information based on the preference information can be adapted to other than the information processing terminal 102. For example, the manager of the calendar service providing server 112 or the like can register only the information which is intended to be provided through the calendar service as the preference information in the calendar service providing server 112. In this case, the calendar service providing server 112 can block from receiving unauthorized time/date data 116 or meta data 128 from the time/date information distribution service providing server 118 or the meta information addition service providing server 124.

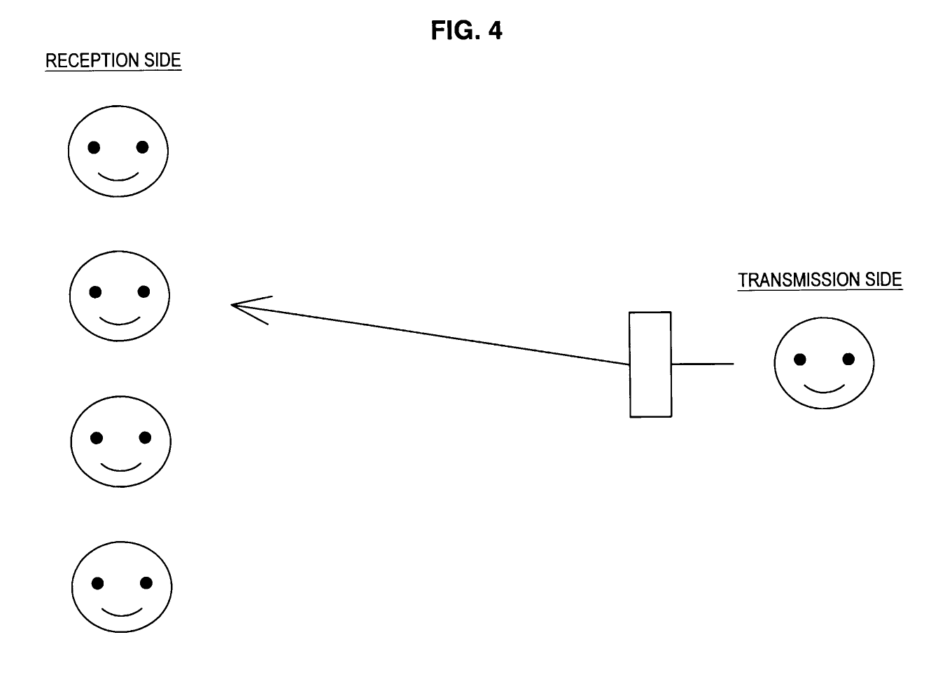

The user's preference information may be registered in not only the information processing terminal 102 but also each providing server. In this case, each providing server can transmit various items of information suitable for the user only to arbitrary users' information processing terminals 102 based on the registered preference information. FIG. 4 is an explanatory diagram showing a concept in which each providing server transmits predetermined information to only specific information processing terminals 102 based on the registered preference information.

As shown in FIG. 4, each providing server can filter the information processing terminals 102 for which predetermined information to be transmitted and preference information are matched among a plurality of information processing terminals, and transmit the information to only the filtered information processing terminals 102. As a result, each providing server can provide the information to only the users desiring the information to be provided.

Each providing server can receive a request signal of requesting to transmit various items of information from only specific information processing terminals 102. For example, each providing server can transmit the information to the information processing terminals 102 only when having received the request signal from the information processing terminals 102 of the service-registered users.

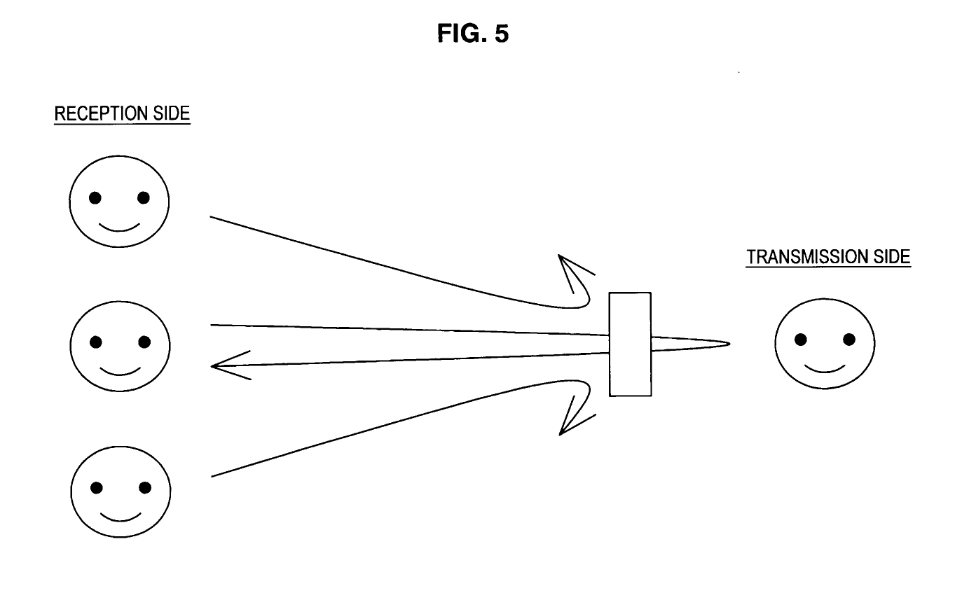

FIG. 5 is an explanatory diagram showing a concept in which each providing server receives a request signal of requesting to transmit various items of information from only specific information processing terminals 102. As shown in FIG. 5, each providing server can receive only the request signal from the information processing terminals 102 registered in the provided service, and transmit the requested information to only the information processing terminals 102. Each providing server can block the request signal from the information processing terminals 102 which has not been registered in the provided service, for example. Thus, an operator of each providing server or the like can provide the information only to the service-registered users or information processing terminals 102, thereby efficiently developing the business utilizing the time/date information providing system 100.

Each providing server can efficiently transmit a plurality of items of managed information to the information processing terminals 102 or other providing servers by utilizing the preference information, a predetermined similarity retrieving algorithm or the like.

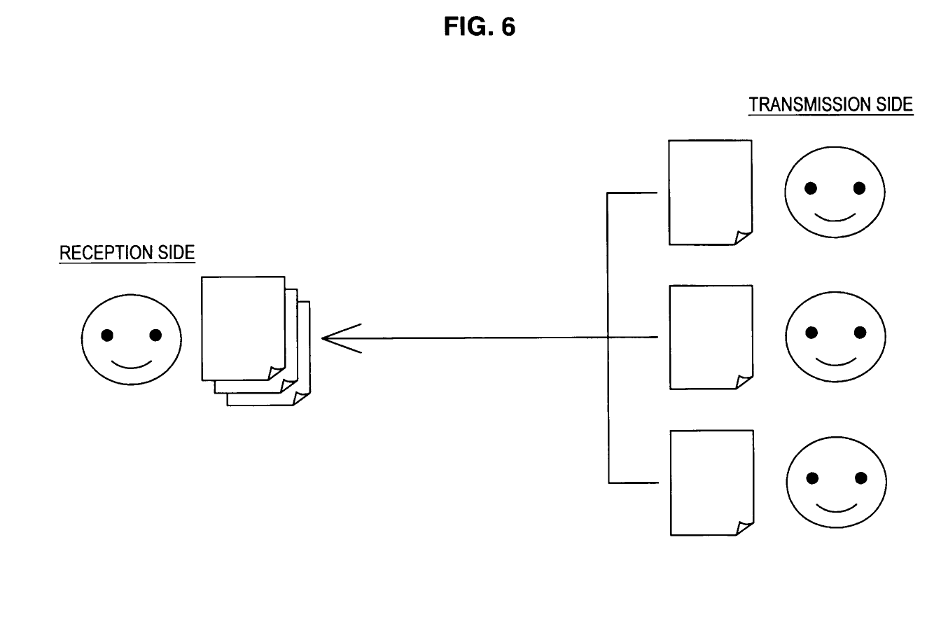

FIG. 6 is an explanatory diagram showing a concept in which each providing server filters only predetermined information together among multiple items of managed information and transmits the same to the information processing terminals 102 or other providing servers. As shown in FIG. 6, each providing server can filter only predetermined information together among multiple items of managed information and transmit the same to the information processing terminals 102 or other providing servers. For example, the time/date information distribution service providing server 118 can extract similar time/date data 116 by the predetermined similarity retrieving algorithm and transmit the extracted items of time/date information 116 together to the information processing terminals 102. Thus, the items of time/date information which have been previously provided by different information providers individually are provided together to the users, which leads to user's improved convenience.

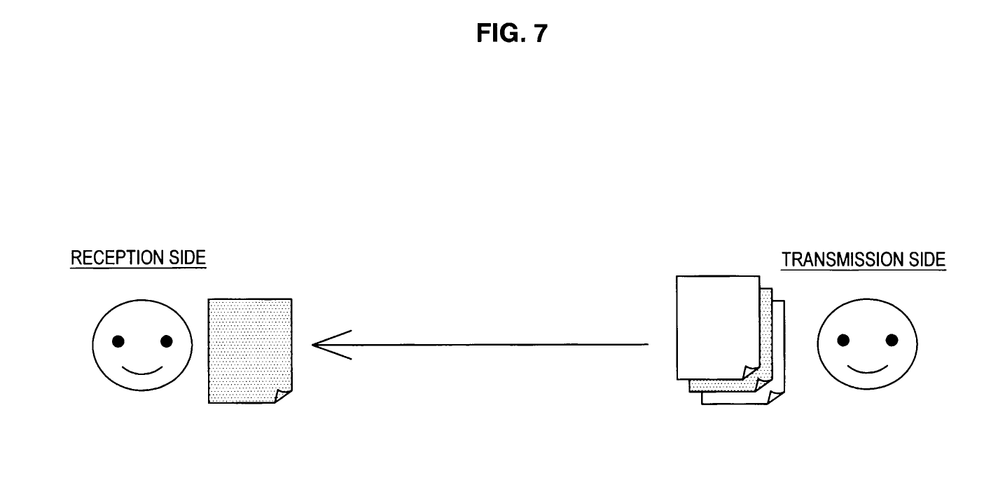

FIG. 7 is an explanatory diagram showing a concept in which only specific information among multiple categories of information provided by a certain information provider is extracted by each providing server and transmitted to the information processing terminals 102. As shown in FIG. 7, when a certain information provider provides multiple different categories of information to the users, each providing server can extract only specific information from the information and transmit the same to the information processing terminals 102. Each providing server can transmit only specific information suitable for preference information to predetermined information processing terminals 102 based on the user-registered preference information, for example. As a result, the information provider can extract and efficiently provide only the information suitable for each user (information processing terminal 102) also when providing multiple different categories of information.

In this manner, in the time/date information providing system 100 according to the present embodiment, the transmission destinations or reception destinations of various items of information are arbitrarily restricted or filtered, thereby efficiently transmitting and/or receiving the information. The examples shown in FIGS. 3 to 7 are merely exemplary for explaining the concept of the transmit and/or receive of various items of information, and the transmitting and/or receiving method is not limited to the examples.

(4. Conclusion)

There has been described above the time/date information providing system 100 according to one embodiment of the present invention in detail. As stated above, the calendar service providing server 112 can not only provide the calendar service of managing user's own schedule but also provide various items of time/date information desired by information providers such as sponsors to the users in association with the calendar information. Thus, the user can view the time/date information on various products or events when utilizing the calendar service to view his/her schedule. Further, the user can perform schedule management on the release date of product or the time/date of event together with his/her schedule by registering the time/date information on preferred product or event in the calendar service.

The calendar service providing server 112 can provide various items of meta information desired by the information providers such as sponsors together with the time/date information in association with the calendar information to the users when providing the calendar service. Thus, the user can not only perform schedule management on the time/date information on preferred products or events but also view detailed information on the products or events.

As a result, the user does not need to acquire the time/date information or meta information by utilizing different recording mediums or methods. Further, the user does not need to save the time/date information or the meta information in the information processing terminal 102, thereby viewing the time/date information or the meta information via the communication network 110 from multiple information processing terminals 102. Furthermore, the user can view and acquire various items of information when utilizing the calendar service to view his/her schedule, thereby efficiently preventing from forgetting to acquire the time/date information.

Further, the information provider can also utilize the time/date information providing system 100 to efficiently provide time/date information or meta information to all the users utilizing the calendar service only by registering the provision-intended time/date information or meta information in each providing server. Consequently, the information provider does not need to distribute the time/date information via multiple information mediums such as television, newspapers and radio, thereby efficiently providing the provision-intended time/date information to the users.

Furthermore, the use of the time/date information providing system 100 enables each providing server's manager to further develop the business. For example, since the information provider can manage the relationship between the provider (sponsor) and the user of the time/date information, it can also propose an accounting system via a user's access to the time/date information. For example, the information provider can propose an accounting system such as accounting for each data, accounting for each event, accounting for each set of similar events, or monthly or yearly subscription. Further, the manager providing the calendar service can propose an accounting system depending on the amount of registration of various items of information from the information providers providing time/date information or meta information.

As stated above, the time/date information providing system 100 according to one embodiment of the present invention can efficiently provide various items of time/date information on release dates or event information via a communication network.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2008-287515 filed in the Japan Patent Office on 10 Nov. 2008, the entire content of which is hereby incorporated by reference.

What is claimed is:

1. A time/date information providing system comprising:
a time/date information providing server for managing time/date information which is registered by information providers for providing various items of information associated with time and date as the time/date information;
a calendar service providing server for providing a calendar service of performing schedule management on a user's schedule in association with time and date, acquiring the time/date information registered in the time/date information providing server, and providing the time/date information to the user in the calendar service; and
at least one or more information processing terminals for accessing the calendar service providing server or the time/date information providing server via a communication network to acquire the time/date information from the calendar service providing server or the time/date information providing server.

2. The time/date information providing system according to claim 1, wherein when the user selects predetermined time/date information via the information processing terminal, the calendar service providing server manages the time/date information in association with information on the user's schedule to provide the calendar service.

3. The time/date information providing system according to claim 2, further comprising a meta information providing server for managing meta information which is registered by meta information providers for providing the meta information associated with the time/date information,
wherein the information processing terminal accesses the meta information providing server via the communication network to acquire the meta information.

4. The time/date information providing system according to claim 3, wherein the time/date information providing server acquires the meta information registered in the meta information providing server, and adds the meta information to time/date information registered by the information providers for management.

5. The time/date information providing system according to claim 3, wherein the calendar service providing server acquires the time/date information registered in the time/date information providing server every preset constant period.

6. The time/date information providing system according to claim 1, wherein the calendar service providing server manages information on preference of the user as preference information, and provides only time/date information suitable for the preference information among the time/date information to the user in the calendar service.

7. The time/date information providing system according to claim 6, wherein the time/date information is managed in the time/date information providing server and the calendar service providing server while being stylized in a preset format.

8. A time/date information providing method, comprising the steps of:
registering time/date information in a time/date information providing server by information providers for providing various items of information associated with time and date as the time/date information;
acquiring the time/date information registered in the time/date information providing server by a calendar service providing server for providing a calendar service of managing a user's schedule in association with time and date to the user; and
providing the time/date information to the information processing terminal by the time/date information providing server when an access is made to the time/date information providing server via a communication network from at least one or more information processing terminals, and providing the time/date information to the information processing terminals in the calendar service by the calendar service providing server when an access is made to the calendar service providing server.
